(19) United States
(12) Patent Application Publication
(10) Pub. No.: US 2026/0070755 A1
(43) Pub. Date: Mar. 12, 2026

(54) CABLE OR PIPE WRAPPING SYSTEM

(71) Applicant: Cable Protect North America, Inc., Robbinsville, NJ (US)

(72) Inventor: Theo Saathoff, Oppenau (DE)

(73) Assignee: Cable Protect North America, Inc., Robbinsville, NJ (US)

(21) Appl. No.: 19/087,540

(22) Filed: Mar. 23, 2025

Related U.S. Application Data
(60) Provisional application No. 63/692,513, filed on Sep. 9, 2024.

(51) Int. Cl. B65H 81/08

(52) U.S. Cl. CPC B65H 81/08

(57) ABSTRACT

A system or method for wrapping at least one cable or pipe. The system may include a guide assembly to support the cable or pipe, a support assembly to support a roll of a wrapping material, a conformator for wrapping the wrapping material around the cable or pipe, and a winder subsystem for wrapping a thread around the wrapped cable or pipe. The conformator may include an inlet portion and a wrapping portion that are integrally connected. The inlet portion may be funnel shaped. The wrapping portion may be cylindrical shaped. The wrapping portion may have sidewalls that are arranged in a spiral so that an edge of one of the sidewalls overlaps an edge of the other one of the sidewalls. The wrapping material may extend through a gap between the overlapping edges of the sidewalls to facilitate the wrapping of the wrapping material around the cable or pipe.

### CROSS-REFERENCE TO RELATED APPLICATIONS

The present application claims the benefit of priority to United States Provisional Patent Application Ser. No. 63/692,513, filed Sep. 9, 2024, the entirety of which is incorporated herein by reference.

### BACKGROUND

Cables, conduits, and pipes that carry electricity and/or fluids may be buried in the ground. To achieve this, a trench is dug and then the cable or pipe is placed into the trench. The trench may be filled with sand that completely surrounds and covers the cable or pipe to prevent any damage to the cable or pipe. The process of transporting sand to the site and removing a similar amount of native material from the site can be labor and cost-intensive.

An alternative to sand is to reuse the native materials as backfill. This requires that any/all native materials not be larger than ⅜ inch in size. To meet this requirement, the native materials must be screened through a screening machine and then gently padded onto the placed cables, conduits, or pipe. Specialized and very costly pieces of machinery are required to be used to achieve this. In addition, skilled and qualified personnel must operate the machinery and a qualified quality person must witness, document, and inspect the process. During this process, an owner's inspection is also required to audit the backfill before any other backfilling operations can follow. This scope of the installation is very time-consuming and very costly. Furthermore, it is difficult to guarantee that native materials larger than ⅜″ have not penetrated through the screening process (especially when the native materials are cohesive type soils) and are not laying on the delicate power cable or pipes resulting in a historical number of anomalies, repairs, rework and expensive repairs.

It has been found that cables and pipes may be wrapped in a protective material prior to being buried in the ground, and that this process may eliminate the need for any sand, instead allowing the native material to be used to refill the trench to bury the cable or pipe. This process may also eliminate the requirement that the native material fulfill specific requirements prior to being reused as the backfill. In either case, there remains a need for improvements in the systems and methods for wrapping cables and pipes that are to be buried underground.

### SUMMARY

The invention may be directed to a system and/or method for wrapping at least one cable or pipe. The system may include a guide assembly to support the cable or pipe, a support assembly to support a roll of a wrapping material, a conformator for wrapping the wrapping material around the cable or pipe, and a winder subsystem for wrapping a thread around an exterior of the wrapped cable or pipe. The conformator may include an inlet portion and a wrapping portion that are integrally connected. The inlet portion may be funnel shaped. The wrapping portion may be cylindrical shaped. The wrapping portion may have sidewalls that are arranged in a spiral relative to one another so that an edge of one of the sidewalls overlaps an edge of the other one of the sidewalls. The wrapping material may extend through a gap between the overlapping edges of the sidewalls to facilitate the overlapping of the wrapping material around the cable or pipe.

In one aspect, the invention may be a system for wrapping at least one cable or pipe, the system comprising: a guide assembly configured to support the at least one cable or pipe; a support assembly configured to support a roll of a wrapping material; a conformator comprising an inlet, an outlet, and a wrapping passageway extending from the inlet to the outlet, the conformator configured to receive the wrapping material and the at least one cable or pipe within the wrapping passageway and to wrap the wrapping material around the at least one cable or pipe as the wrapping material and the at least one cable or pipe are moved through the wrapping passageway, the conformator comprising: an inlet portion configured to receive the at least one cable or pipe and the wrapping material, the inlet portion being half-funnel shaped such that a diameter of the inlet portion decreases in a direction from the inlet of the conformator towards a distal end of the inlet portion; a wrapping portion extending from the distal end of the inlet portion and being configured to wrap the wrapping material around an exterior of the at least one cable or pipe so that a wrapped cable or pipe assembly exits the conformator at the outlet of the conformator; and a winder subsystem located downstream of the outlet of the conformator and configured to wind a thread around an exterior of the wrapped cable or pipe assembly to secure the wrapping material to the at least one cable or pipe.

In another aspect, the invention may be a system for wrapping at least one cable or pipe, the system comprising: a guide assembly configured to receive and support the at least one cable or pipe, the guide assembly comprising an inlet guide assembly; a support assembly configured to support a roll of a wrapping material, the support assembly located below the inlet guide assembly; a conformator comprising an inlet, an outlet, and a wrapping passageway extending along a longitudinal axis from the inlet to the outlet, the conformator configured to receive the wrapping material and the at least one cable or pipe within the wrapping passageway and to wrap the wrapping material around the at least one cable or pipe as the wrapping material and the at least one cable or pipe are moved through the wrapping passageway, the conformator comprising: a funnel shaped inlet portion, the funnel shaped inlet portion being horizontally oriented and comprising the inlet of the conformator, a distal end opposite the inlet, and an open top end; a cylindrical shaped wrapping portion, the cylindrical shaped wrapping portion being horizontally oriented and comprising the outlet of the conformator and an open top end, the cylindrical shaped wrapping portion being integrally connected to the distal end of the funnel-shaped inlet portion; a first lid pivotably coupled to the cylindrical shaped wrapping portion on a first side of the longitudinal axis; a second lid pivotably coupled to the cylindrical shaped wrapping portion on a second side of the longitudinal axis; wherein each of the first and second lids is alterable between an open position whereby the first and second lids are pivoted away from the longitudinal axis and a closed position whereby the first and second lids close at least a portion of the open top end of the cylindrical shaped wrapping portion; and wherein when the first and second lids are in the closed position, a second edge portion of the second lid overlaps a first edge portion of the first lid while a space is maintained between the second edge portion of the second lid and the first edge portion of the first lid.

In yet another aspect, the invention may be a system for wrapping at least one cable or pipe, the system comprising: a guide assembly configured to support at least one cable or pipe; a support assembly configured to support a roll of a wrapping material; a conformator configured to wrap the wrapping material around the at least one cable or pipe to form a wrapped cable or pipe assembly; and a winder subsystem located downstream of the conformator and configured to wind a thread around an exterior of the wrapped cable or pipe assembly to secure the wrapping material to the at least one cable or pipe, the winder subsystem comprising a drum comprising: a first end and, a second end, and a winder passageway that extends from the first end to the second end; a first drum component comprising a first main body portion having an elongated gap that extends from the first end of the drum to the second end of the drum; and a second drum component comprising a second main body portion that extends from the first end of the drum to the second end of the drum; and wherein the second drum component is alterable between an attached state wherein the second main body portion of the second drum component is positioned within the elongated gap of the first main body portion of the first drum and a detached state wherein the second drum component is detached from the first drum component and the elongated gap defines an opening into the winder passageway of the drum.

In still another embodiment, the invention may be a method for wrapping at least one cable or pipe, the method comprising: supporting a cable or pipe with a guide assembly of a wrapping apparatus; supporting a roll of a wrapping material with a support assembly of the wrapping apparatus; feeding the cable or pipe and a sheet of the wrapping material through an inlet of a conformator of the wrapping apparatus and into a wrapping passageway of the conformator, the conformator comprising: an inlet portion that is half-funnel shaped such that a diameter of the inlet portion decreases in a direction from the inlet of the conformator towards a distal end of the inlet portion, the inlet portion comprising the inlet; and a wrapping portion extending from the distal end of the inlet portion and being configured to wrap the wrapping material around an exterior of the at least one cable or pipe so that a wrapped cable or pipe assembly exits the conformator at an outlet of the conformator; and feeding the wrapped cable or pipe assembly into a winder subsystem of the wrapping apparatus located downstream of the outlet of the conformator, the winder subsystem winding a thread around an exterior of the wrapped cable or pipe assembly to secure the wrapping material to the at least one cable or pipe.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The features of the exemplary embodiments of the present invention will be described with reference to the following drawings, where like elements are labeled similarly, and in which:

FIG. 1 is a perspective view of a system for wrapping at least one cable or pipe in accordance with an embodiment of the present invention;

FIG. 2 is a perspective view of the system of FIG. 1 without a vehicle supporting the system;

FIG. 3 is a side view of the system of FIG. 2;

FIG. 4A is a detail view of a portion of the system of FIG. 2 focusing on a winder subsystem;

FIG. 4B is the detail view of FIG. 4A with a panel of the winder subsystem removed for internal visibility;

FIG. 4C is a cross-sectional view taken along line IVC-IVC of FIG. 4A;

FIG. 4D is a detail view of the winder subsystem of FIG. 4A, with a lid thereof in an open position;

FIG. 4E is a detail view of a portion of the winder subsystem of FIG. 4E;

FIG. 5A is a perspective view of a conformator of the system of FIG. 1;

FIG. 5B is the perspective view of the conformator of FIG. 5A with first and second lids pivoted into an open position;

FIG. 5C is a side view of the conformator of FIG. 5A;

FIG. 5D is a top plan view of the conformator of FIG. 5A;

FIG. 5E is a cross-sectional view taken along line VE-VE of FIG. 5D;

FIG. 5F is a cross-sectional view taken along line VF-VF of FIG. 5A;

FIG. 6A is a perspective view of the system of FIG. 2, illustrating a plurality of cables and a roll of a wrapping material;

FIG. 6B is the perspective view of FIG. 6A, with the plurality of cables and the wrapping material being moved further along through the system;

FIG. 6C is the perspective view of FIG. 6B, with the plurality of cables and the wrapping material having reached the conformator, which wraps the plurality of cables within the wrapping material;

FIG. 6D is a detail view of area VID of FIG. 6C;

FIG. 6E is the perspective view of FIG. 6B illustrating the wrapped cables exiting via an outlet of the winder subsection;

FIG. 7 is a perspective view of a drum of the winder subsystem in accordance with an embodiment of the present invention with a first drum component and a second drum component in an attached state;

FIG. 8 is a perspective view of the drum of the winder subsystem of FIG. 7 with the first and second drum components in a detached state;

FIG. 9A and FIG. 9B are perspective views of the first drum component of the drum of the winder subsystem of FIG. 7;

FIG. 10A and FIG. 10B are perspective views of the second drum component of the drum of the winder subsystem of FIG. 7;

FIG. 11A is a perspective view of the system with the second drum component in the detached state and shown exploded relative to the first drum component; and

FIG. 11B is a close-up view of area XI of FIG. 11A.

### DETAILED DESCRIPTION

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range.

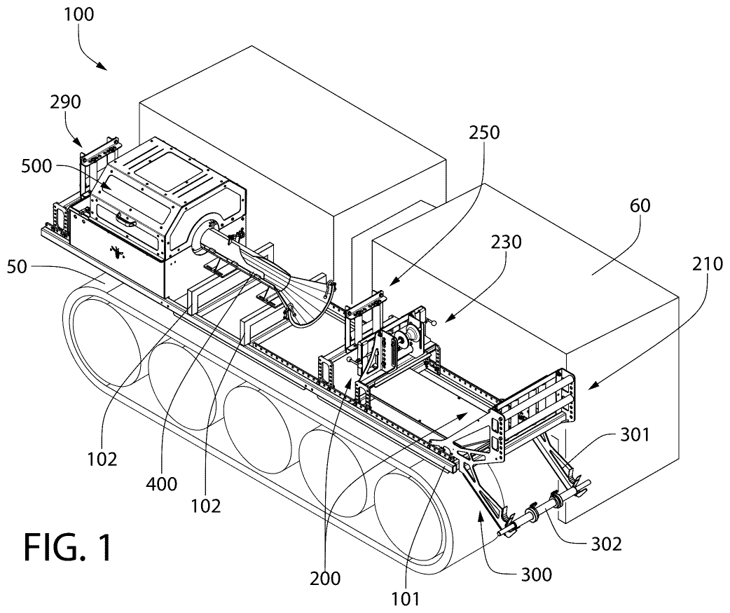

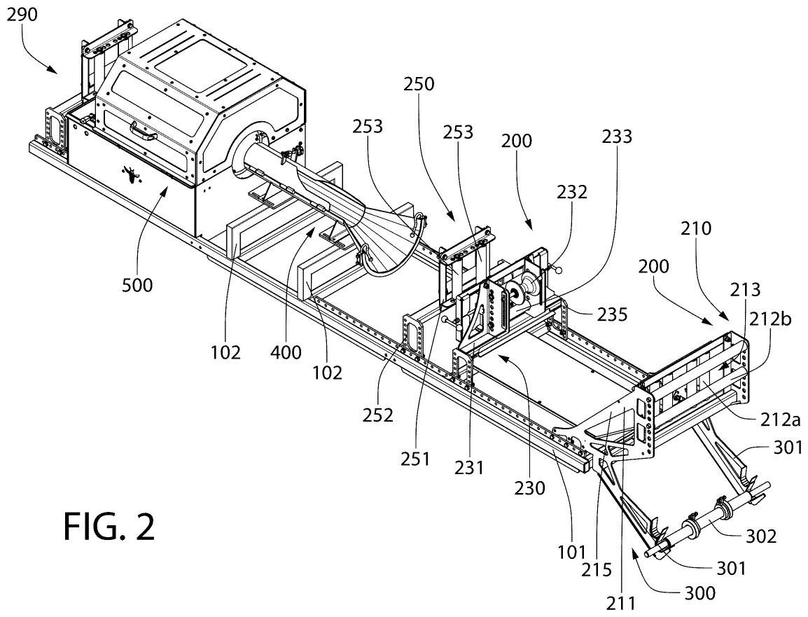

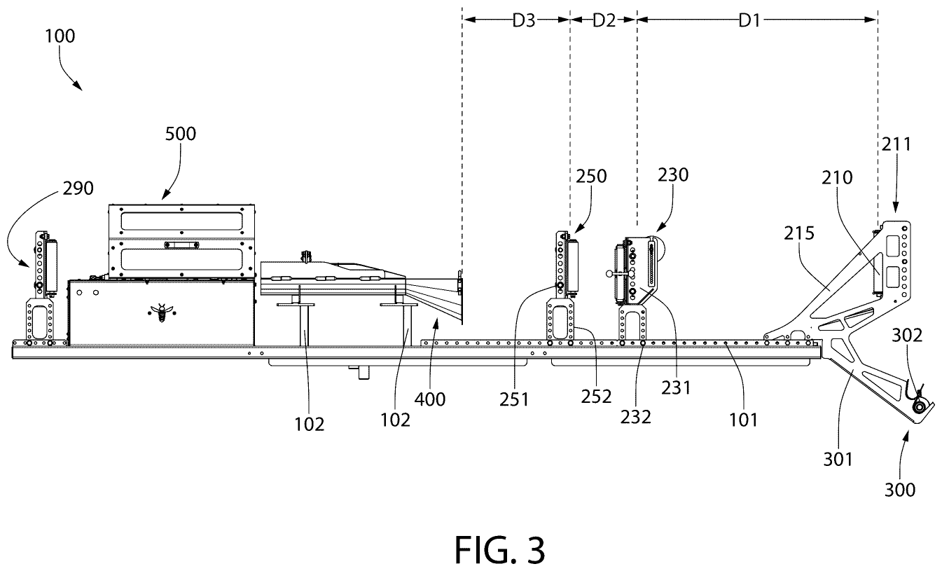

Referring to FIGS. 1-3, a system 100 for wrapping at least one cable or pipe is illustrated. The system 100 generally comprises a main frame 101 that may be mounted to a vehicle 50, with additional components, assemblies, and subsystems of the system 100 being coupled to the main frame 101. The vehicle 50 may be a tractor, a trailer, a truck, or any other transport apparatus suitable for the purpose as described herein. The main frame 101 may be mounted to the vehicle 50 such that movement of the vehicle 50 transports and moves the main frame 101 and the components coupled thereto, such as during a cable or pipe wrapping operation as described herein. The system 100 may further comprise an electronics subsystem 60 mounted on the vehicle 50. The electronics subsystem 60 may comprise the electronic components required for operation of the system 100, including processors that are programmed to facilitate operation of the system 100, power sources, and the like. After system setup, the system 100 may automatically wrap cables or pipes in a wrapping material as the vehicle 50 moves relative to the cables or pipes, thereby causing the cables or pipes to move through the various stages of the system 100 as described further below.

The system 100 may comprise an introductory guide assembly 200 that is configured to support and orient that at least one cable or pipe as the at least one cable or pipe moves through the system 100, a support assembly 300 that is configured to support a roll of a wrapping material, a conformator 400 that is configured to perform the function of wrapping the at least one cable or pipe in the wrapping material, and a winder subsystem 500 that is configured to wrap a thread around the wrapped cable or pipe to secure everything in place. The system 100 may further comprise an exit guide assembly 290 that is configured to support the wrapped cable or pipe as the wrapped cable or pipe exits via the outlet of the winder subsystem. Each of the various assemblies and parts noted may be coupled to the main frame 101. Furthermore, the specific positioning of the various assemblies and parts on the main frame 101 may be adjustable. That is, the spacing between the assemblies and parts on the frame 101 may be adjustable. In some embodiments, the relative positions of the assemblies and parts on the frame 101 should be as specified herein.

The introductory guide assembly 200 may comprise an inlet guide assembly 210, a trefoil guide assembly 230, and an outlet guide assembly 250. The introductory guide assembly 200 may be located entirely upstream of the conformator 400, meaning each of the inlet, trefoil, and outlet guide assemblies 210, 230, 250 may be located upstream of the conformator 400. The term “upstream” as used herein refers to a relative location or position of a component being closer to the inlet guide assembly 210 and the term “downstream” as used herein refers to a relative location or position of a component being closer to the exit guide assembly 290. The introductory guide assembly 200 may carry and support the at least one cable or pipe from a source of the cable or pipe to the conformator 400 and the winder subsystem 500 to perform the wrapping and winding operations as described herein. The source of the at least one cable or pipe may be a roll or reel of the cable or pipe that is on a drum. The roll or reel of the cable or pipe may be carried on a transport vehicle that is in front of the system 100 during wrapping operations, as will be described in more detail below.

The inlet guide assembly 210 may comprise a first support frame 211 that is coupled to the main frame 101 and a plurality of cylindrical roller members 212 that are coupled to the first support frame 211. The plurality of cylindrical roller members 212 may comprise vertically oriented roller members 212a and horizontally oriented roller members 212b that are positioned in an intersecting arrangement to define openings 213 through which cables or pipes may be inserted. The number of vertically oriented and horizontally oriented roller members 212a, 212b may be adjusted and modified depending on the type, size, and number of pipes or cables that are being wrapped. The cylindrical roller members 212 may be rotationally coupled to the first support frame 211 so that the cylindrical roller members 212 rotate about a rotational axis as the cables or pipes are being moved through the system 100.

The trefoil guide assembly 230 may comprise a second support frame 231 that is coupled to the main frame 101. The second support frame 231 may comprise a stand portion 235 that is coupled to opposing sides of the main frame 101 to lift/elevate the trefoil guide assembly 230 above the main frame 101. The trefoil guide assembly 230 may further comprise a set of rollers that are coupled to the second support frame 231. The rollers of the trefoil guide assembly 230 may be configured to position the plurality of cables in a trefoil arrangement whereby two of the cables are side-by-side and a third cable is positioned atop of the two side-by-side cables and rests on an interface of the two side-by-side cables. The rollers of the trefoil guide assembly 230 may comprise an hourglass roller 232 and a horizontal cylindrical roller 233 that are spaced apart. As the cables approach the trefoil guide assembly 230, the cables pass into the space between the hourglass roller 232 and the horizontal cylindrical roller 233, which forces the cables into the trefoil arrangement. The hourglass roller 232 and the horizontal cylindrical roller 233 may be configured to rotate about their rotational axes as the cables or pipes pass therethrough. If a single pipe or cable is being wrapped, the single pipe or cable may pass through the trefoil guide assembly 230. Alternatively, if a single pipe or cable is being wrapped such that a trefoil arrangement of the pipe/cable is not needed, the trefoil guide assembly 230 may be detached from the main frame 101.

The outlet guide assembly 250 is located downstream of the trefoil guide assembly 230. Thus, the trefoil guide assembly 230 is located between the inlet guide assembly 210 and the outlet guide assembly 250. In one embodiment, the trefoil guide assembly 230 may be spaced a first distance D1 from the inlet guide assembly 210 and the trefoil guide assembly 230 may be spaced a second distance D2 from the outlet guide assembly 250. The first distance D1 may be greater than the second distance D2. The outlet guide assembly 250 may also be spaced a third distance D3 from the conformator 400. The third distance D3 may be greater than the second distance D2 and less than the first distance D1.

The outlet guide assembly 250 may comprise a third support frame 251 that is coupled to the main frame 101. The third support frame 251 may comprise a stand portion 252 that is coupled to the main frame 101 to lift/elevate the outlet guide assembly 250. The outlet guide assembly 250 may comprise a pair of vertical cylindrical rollers 253 that are spaced apart. Each of the pair of vertical cylindrical rollers 253 may be configured to rotate about their longitudinal axes. The at least one cable or pipe will pass through the opening defined between the pair of cylindrical rollers 253 prior to the cable or pipe entering the conformator 400. The outlet guide assembly 250 may help to maintain the cables in the trefoil configuration when desired, and may ensure that the at least one cable or pipe is aligned with an inlet of the conformator so that the at least one cable or pipe moves from the guide assembly 200 to the conformator 400 during the wrapping procedure as described herein below.

The support assembly 300 may comprise a pair of support arms 301 and a support rod 302 that extends between the pair of support arms 301. The pair of support arms 301 may be integrally formed with the first support frame 211. The support frame 211 may comprise arms 215 that extend upwardly and outwardly from the main frame 101 and the pair of support arms 301 may extend downwardly and outwardly from the main frame 101. As such, the positioning of the support rod 302, and hence also the roll of wrapping material supported thereon, may be fixed relative to the positioning of the inlet guide assembly 210 since they are formed as a monolithic part. The support rod 302 may be located below or beneath the first support frame 211 of the inlet guide assembly 210. As noted, the support rod 302 of the support assembly 300 is configured to hold and support a roll of a wrapping material thereon. The support rod 302 supports the roll of the wrapping material below the guide assembly 200 which is configured to support the at least one cable or pipe. Thus, the roll of the wrapping material may be located below or beneath the at least one cable or pipe as the at least one cable or pipe is transported through the system 100. The wrapping material may be unrolled from the roll so as to form a sheet of the wrapping material that is transported through the system 100 as described herein below.

The conformator 400 and the winder subsystem 500 will be described in greater detail below. It is worth noting here that the conformator 400 is coupled to the main frame 101 by one or more conformator support members 102. The conformator support members 102 may be coupled directly to the main frame 101 and to a bottom of the conformator 400 to support the conformator 400 in an elevated position relative to the main frame 101. The conformator 400 should be positioned and oriented so that it can receive the at least one cable or pipe and the sheet of the wrapping material as they move through the system 100. The structure of the conformator 400 is designed to automatically wrap the at least one cable or pipe in the wrapping material as the at least one cable or pipe and the wrapping material are moved through the conformator 400.

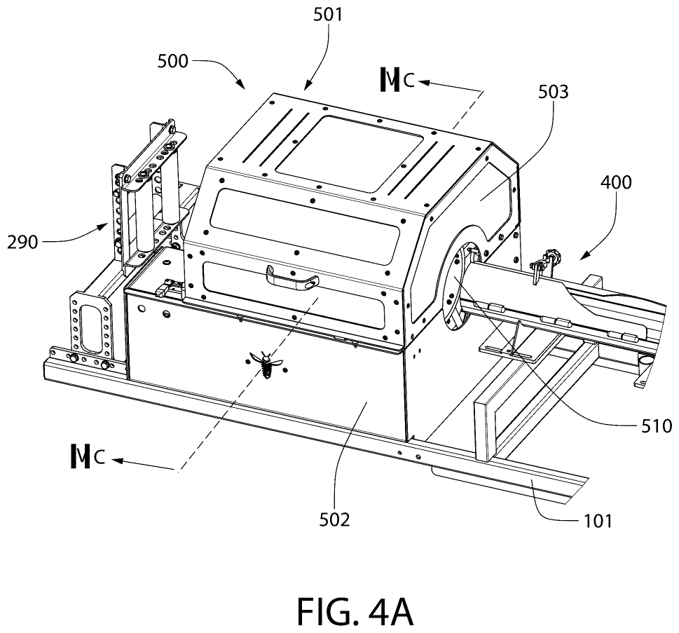

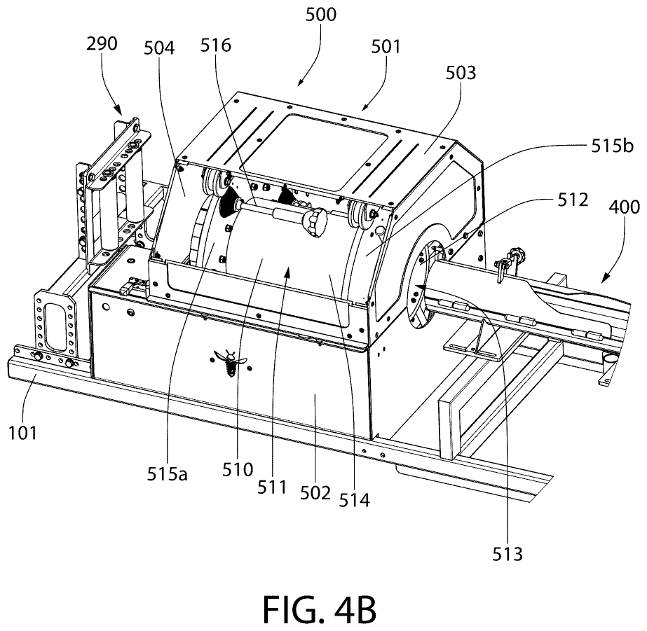

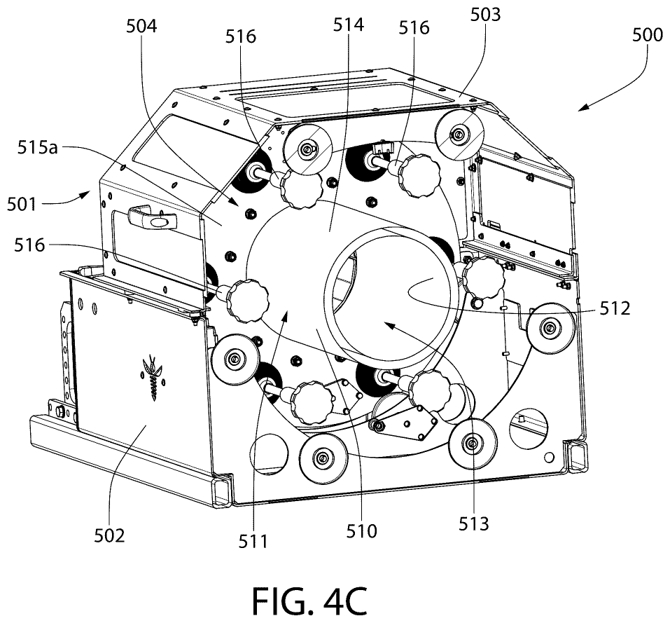

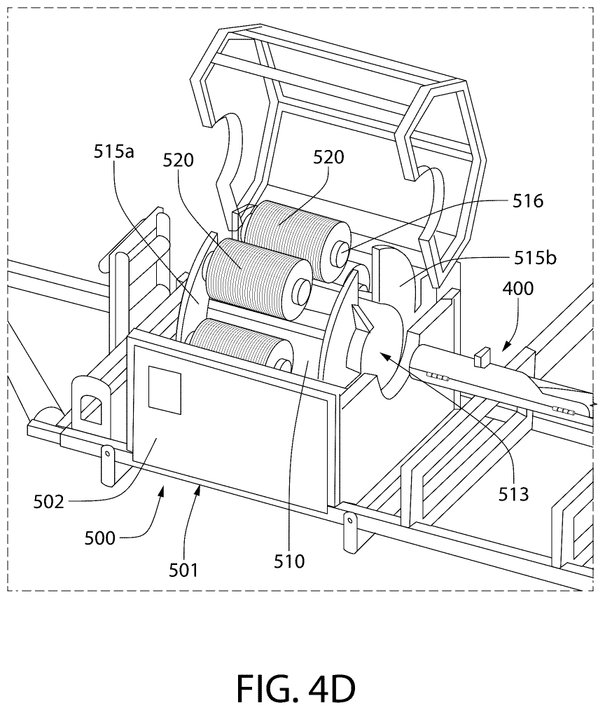

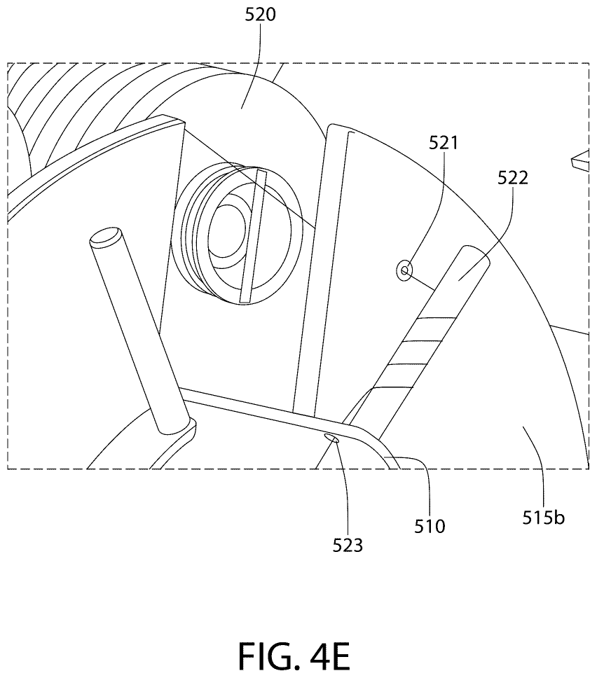

Referring to FIGS. 4A-D, the winder subsystem 500 will be described. The winder subsystem 500 is located downstream of the conformator 400 and is configured to wrap a winding material around the exterior of the one or more cables or pipes that were wrapped in the wrapping material within the conformator 400. Thus, the winder subsystem 500 wraps a winding material around the exterior of the wrapping material which in turn is placed around and encloses the one or more cables or pipes. The wrapping of the winding material around the exterior of the wrapping material secures the wrapping material and prevents the wrapping material from unwrapping or otherwise disengaging from the one or more cables or pipes. The winder subsystem 500 may be configured to wind the winding material around the wrapped cable or pipe in a spiral or helical configuration. The winding material may be thread, twine, wire, strands of cotton, nylon, or other fibers, or any other material which has the capability of being wound around the exterior of the wrapped cable or pipe using the winder subsystem 500 as described herein.

In the exemplified embodiment, the winder subsystem 500 comprises a housing 501 having a base portion 502 and a cover portion 503. The housing 501 may be supported on the main frame 101. The cover portion 503 may be alterable between a closed position (FIG. 4A) and an open position (FIG. 4D). The cover portion 503 may be altered into the open position to allows a user to replace the reels of winding material and perform other maintenance as needed. The housing 501 may comprise a cavity 504. The winder subsystem 500 may comprise a drum 510 that is located within the cavity 504. The drum 510 may comprise an outer surface 511 and an inner surface 512 that is opposite the outer surface 511. The inner surface 512 may define a winder passageway 513 that extends from an inlet of the drum 510 to an outlet of the drum 510.

The drum 510 may comprise a main body portion 514 and at least one flange 515 extending radially from an outer surface of the main body portion 514. The main body portion 514 may be cylindrical. In the exemplified embodiment, there are two of the flanges 515 including a first flange 515a and a second flange 515b. The first flange 515a is located proximate to the outlet of the drum 510 and the second flange 515b is located proximate to the inlet of the drum 510. The winder subsystem 500 may comprise a plurality of reel support members 516 coupled to the first flange 515a of the drum 510. In the exemplified embodiment, each of the reel support members 516 is a rod-like member that protrudes from the first flange 515a of the drum 510 in a direction towards the second flange 515b of the drum 510. Each of the reel support members 516 is configured to support a reel of a winding material. As noted above, the winding material may be thread, wire, twine, fabric, string, or the like. The reel support members 516 are coupled to the first flange 515a so that as the drum 510 rotates, the reel support members 516 follow a circular path along with the rotation of the drum 510.

FIG. 4D illustrates the winder subsystem 500 with the cover portion (or lid) 503 in the open state. The cover portion 503 may be altered to the open state to allow a user to place reels of the winding material onto the reel support members 516 or to perform other maintenance. In FIG. 4D, there is a reel of the winding material 520 positioned on each of the reel support members 516. In the exemplified embodiment, there are six of the reel support members 516, and hence also six of the reels of the winding material 520.

FIG. 4E is a close-up detail view illustrating the setup of the winding material from one of the reels of winding material 520. Each of the reels of winding material 520 may be initially set up in this same way. Specifically, in an embodiment, the winding material is unwound from the reel and passed through an upper eyelet 521 in the second flange 515b of the drum 510, wrapped around a post 522, and then passed through a lower eyelet 523 formed into the drum 510 and into the winder passageway 513. The post 522 protrudes directly from the outer surface of the drum so that the post 522 rotates along with the drum. During the setup phase, the end of the winding material (i.e., the string or the like) that is passed through the upper and lower eyelets 521, 523 may be attached to the wrapping material. Specifically, during the setup phase, the at least one cable or pipe and the wrapping material may be pulled through the guide assembly 200 and into and through the wrapping passageway of the conformator 400. The end of the at least one cable or pipe and the wrapping material may be positioned in the space between the conformator 400 and the winder passageway 513 of the drum 510. The string of the winding material that passes through the lower eyelet 523 may be attached (such as by tying, knotting, wrapping, or the like) to the part of the wrapping material that is located in the space between the winder passageway 513 and the wrapping passageway of the conformator 400. Then, when the wrapping material and the at least one cable or pipe is moved through the system and the drum 510 rotates, the winding material (i.e., string or the like) wraps around the exterior of the wrapping material in a helical or spiral pattern.

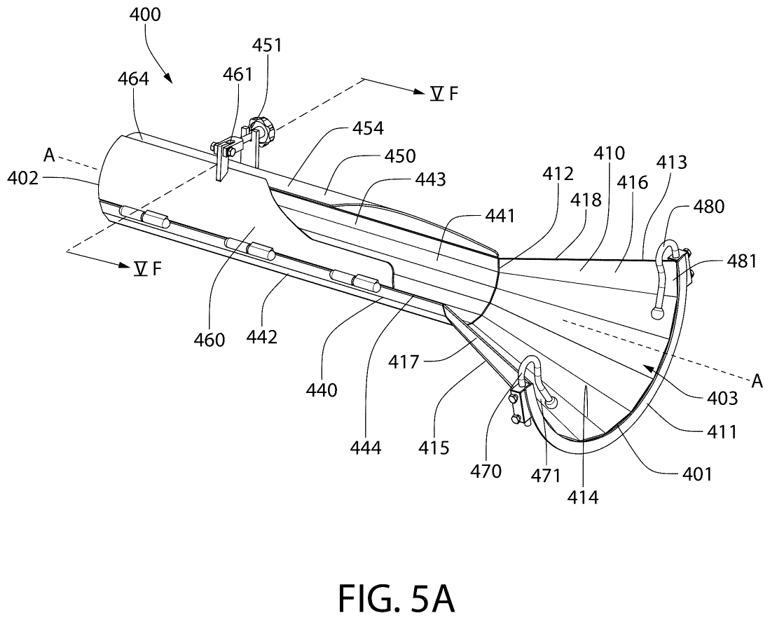

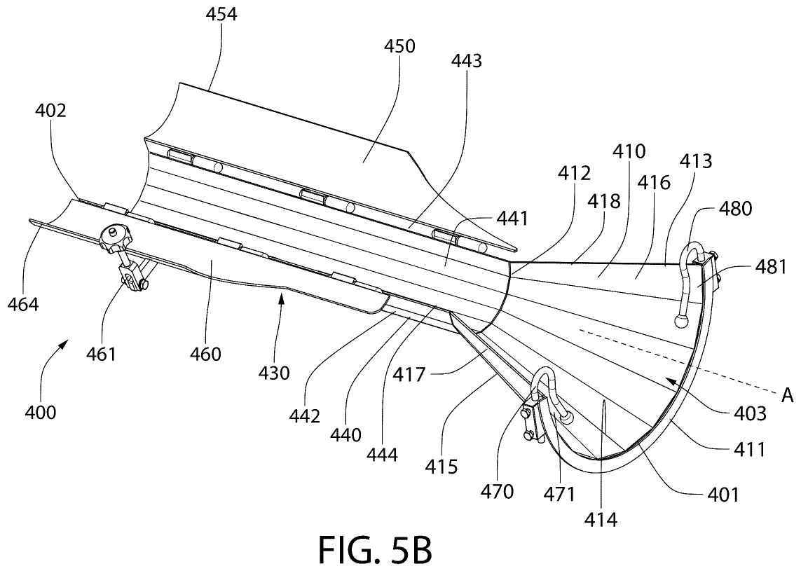

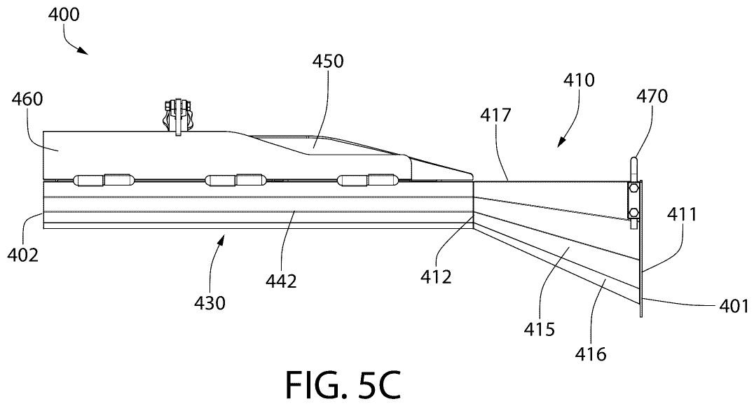

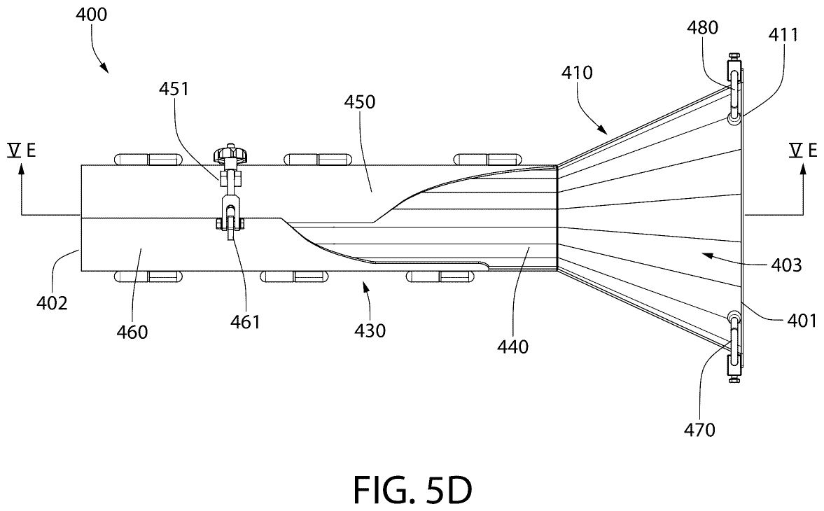

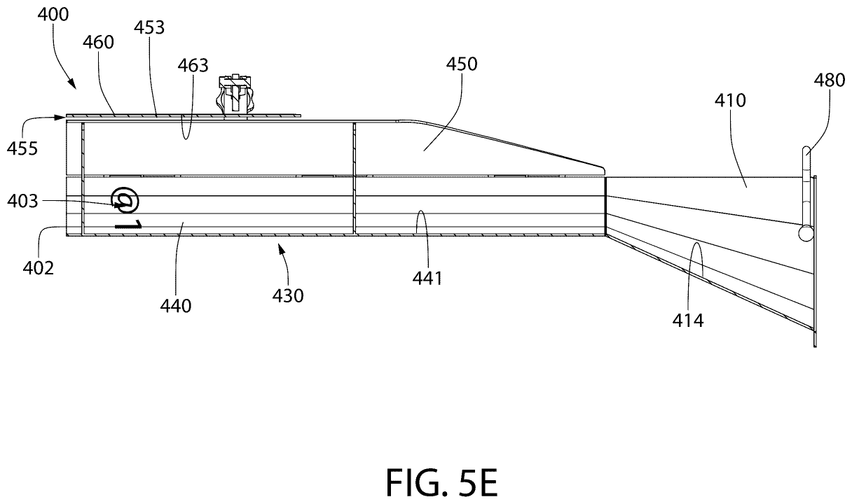

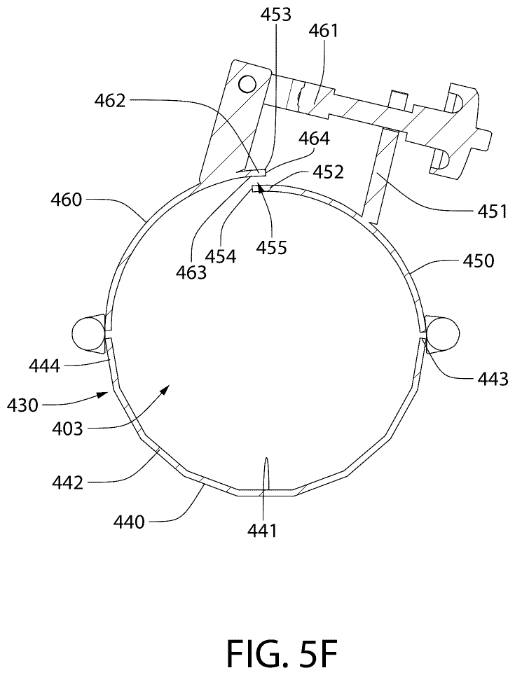

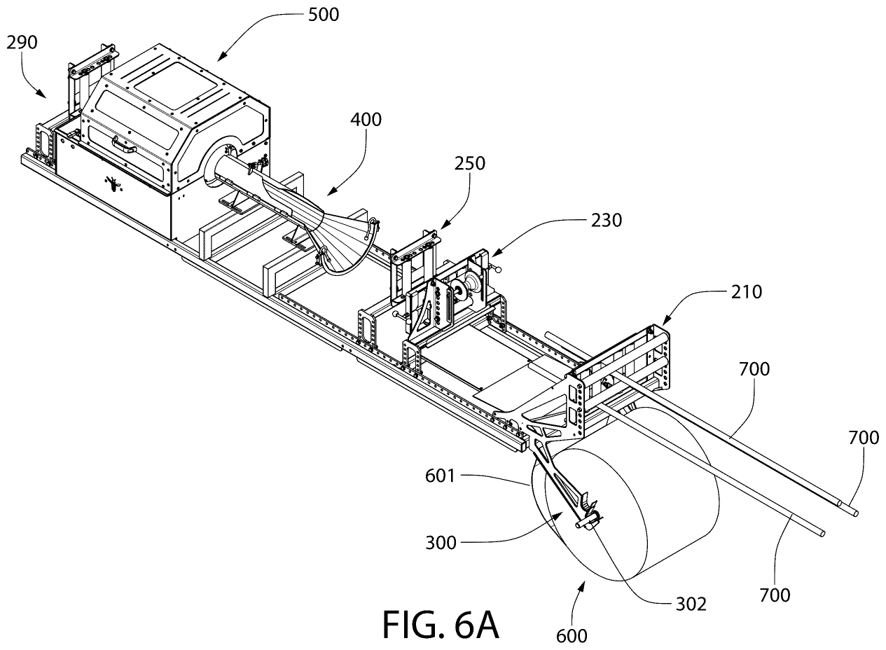

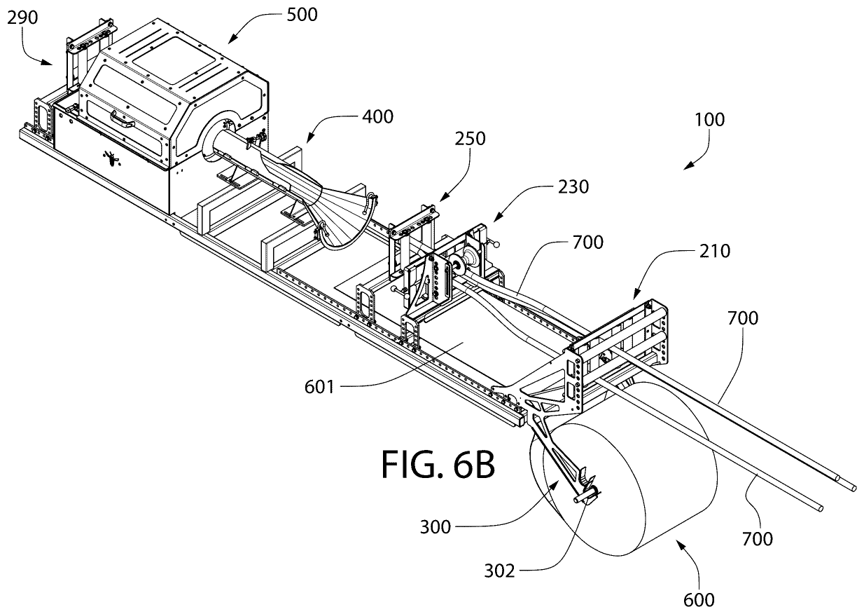

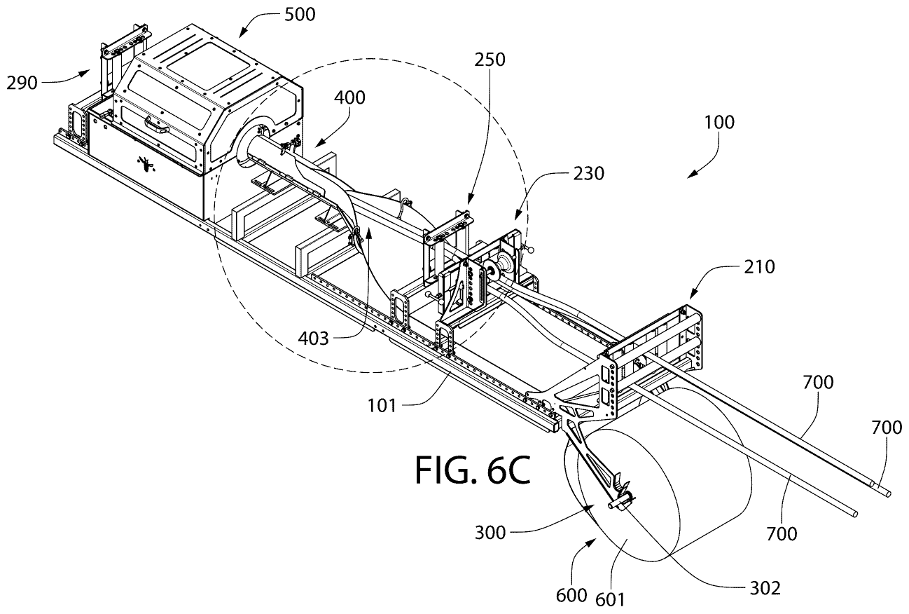

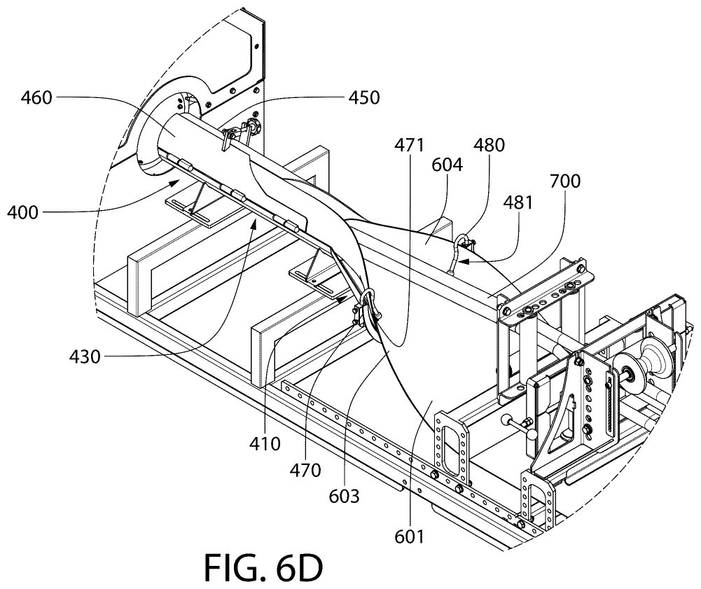

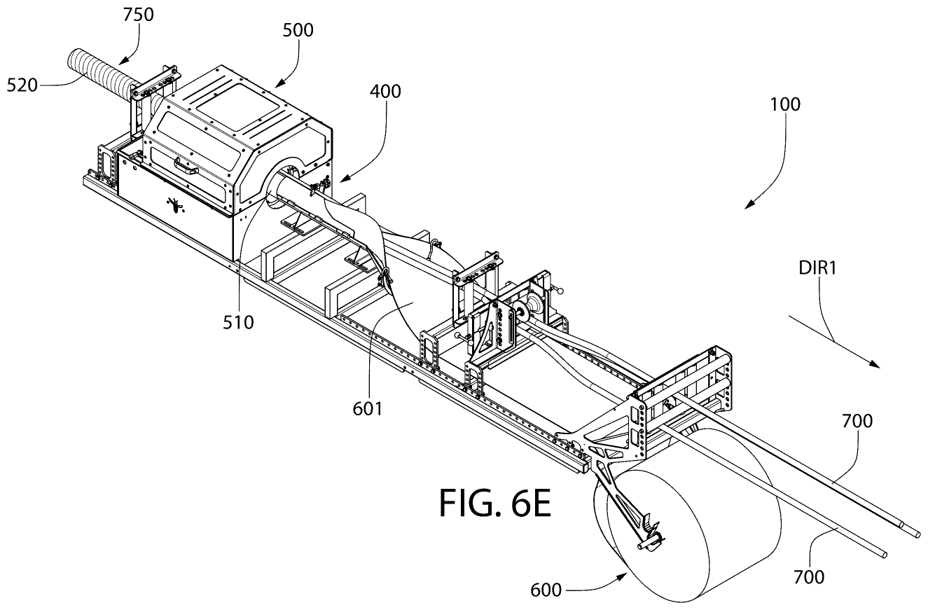

Referring to FIGS. 5A-5F, the conformator 400 will be described. As noted previously, the conformator 400 is the component that facilitates the wrapping of the wrapping material around the at least one cable or pipe. In an embodiment, the wrapping material is wrapped around the at least one cable or pipe within the conformator 400 simply by moving the wrapping material and the at least one cable or pipe through the conformator 400 after setup. This will be described further below with reference to FIGS. 6A-6E.

The conformator 400 comprises an inlet 401, an outlet 402, and a longitudinal axis A-A that extends from the inlet 401 to the outlet 402. The conformator 400 further comprises a wrapping passageway that extends from the inlet 401 to the outlet 402. The conformator 400 is configured to receive the wrapping material and the at least one cable or pipe within the wrapping passageway 403 and to wrap the wrapping material around the at least one cable or pipe as the wrapping material and the at least one pipe are moved through the wrapping passageway 403 from the inlet 401 to the outlet 402.

The conformator 400 may generally comprise an inlet portion 410 that comprises the inlet 401 and a wrapping portion 430 that comprises the outlet 402. The inlet portion 410 may extend from a first end 411 (which is where the inlet 401 is located) to a second end (or a distal end) 412. The wrapping portion 430 may extend from the second end 412 of the inlet portion 410 to the outlet 402 of the conformator 400. The wrapping portion 430 may comprise a body portion 440, a first lid 450 pivotably coupled to the body portion 440, and a second lid 460 pivotably coupled to the bottom portion 460. The body portion 440 of the wrapping portion 430 may be integrally formed with the inlet portion 410 as a monolithic component. The conformator 400 may be formed from metal.

The inlet portion 410 of the conformator 400 may extend from the first end 411 to the second end 412 as noted above. The inlet portion 410 of the conformator 400 may be funnel shaped such that a diameter of the inlet portion 410 decreases in a direction from the first end 411 (or from the inlet 401) towards the second end (or the distal end) 412. More specifically, the inlet portion 410 of the conformator 400 may be half funnel shaped. Specifically, the inlet portion 410 may be shaped like a half funnel that is horizontally oriented. In the horizontal orientation, a top half of the “funnel” shape is removed, such that the inlet portion 410 has an open top end 413. The inlet portion 410 has an inner surface 414 and an outer surface 415. The inner surface 414 may be concave and the outer surface 415 may be convex. Thus, the inlet portion 410 is formed by an arcuate wall 416 that extends from the first end 411 to the second end 412 and that has a width that decreases continuously moving from the first end 411 to the second end 412. The arcuate wall 416 may comprise a first top edge 417 located on a first side of the longitudinal axis A-A and a second top end 418 located on a second side of the longitudinal axis A-A.

A first hook member 470 may be coupled to the inlet portion 410 on a first side of the longitudinal axis A-A and a second hook member 480 may be coupled to the inlet portion 410 on a second side of the longitudinal axis A-A. In the exemplified embodiment, each of the first and second hook members 470, 480 is coupled to the outer surface 415 of the inlet portion 410. However, the first and second hook members 470, 480 could potentially be coupled to the first and second top edges 417, 418 of the arcuate wall 416 of the inlet portion 410 in an alternative embodiment. The first and second hook members 470, 480 may be coupled to the inlet portion 410 at a location that is adjacent to the first end 411 of the inlet portion 410. In an embodiment, neither of the first and second hook members 470, 480 protrudes beyond the first end 411 of the inlet portion 410.

The first hook member 470 is coupled to the inlet portion 410 and extends over a first portion of the inner surface 414 of the inlet portion 410 located on a first side of the longitudinal axis A-A. Specifically, in the exemplified embodiment the first hook member 470 is coupled to the outer surface 415 of the inlet portion 410 adjacent to the first end 411 of the inlet portion 410. The first hook member 470 extends over top of the first side edge 417 and extends over the first portion of the inner surface 414. The first hook member 470 remains spaced apart from the first portion of the inner surface 414 by a first gap 471.

The second hook member 480 is coupled to the inlet portion 410 and extends over a second portion of the inner surface 414 of the inlet portion 410 located on a second side of the longitudinal axis A-A. Specifically, in the exemplified embodiment the second hook member 480 is coupled to the outer surface 415 of the inlet portion 410 adjacent to the first end 411 of the inlet portion 410. The second hook member 480 then extends over top of the second side edge 418 and extends over the second portion of the inner surface 414. The second hook member 480 remains spaced apart from the second portion of the inner surface 414 by a second gap 481.

When the sheet of wrapping material passes through the inlet 401 of the conformator, opposing side edges of the sheet of wrapping material may extend into the first and second gaps 471, 481 while a central portion of the wrapping material is located between the first and second hook members 470, 480. As such, the first and second hook members 470, 480 help to maintain the sheet of wrapping material within the wrapping passageway 403 of the conformator 400 as the sheet of wrapping material moves from the inlet 401 of the conformator 400 to the outlet 402 of the conformator 400 during the wrapping process.

The wrapping portion 430 of the conformator 400 extends from the second end 412 of the inlet portion 410 to the outlet 402 of the conformator 400. As noted above, the wrapping portion 430 of the conformator 400 comprises the body portion 440, the first lid 450, and the second lid 460. Unlike the inlet portion 410, the wrapping portion 430 may have a diameter that is constant from the second end 412 of the inlet portion 410 to the outlet 402 of the conformator 400. Thus, while the inlet portion 410 has a funnel-like shape with an open top end 413, the wrapping portion 430 has a cylindrical shape or a half-cylindrical shape with an open top end. More specifically, the body portion 440 of the wrapping portion 430 may comprise a semi-cylindrical shape. The body portion 440 of the wrapping portion 430 may be oriented horizontally. The body portion 440 of the wrapping portion 430 may comprise an inner surface 441, an outer surface 442, a first top edge 443 located on a first side of the longitudinal axis A-A, and a second top edge 444 located on a second side of the longitudinal axis A-A. The inner surface 441 may be concave and the outer surface 442 may be convex.

The first lid 450 may be pivotably coupled to the body portion 440 on a first side of the longitudinal axis A-A and the second lid 460 may be pivotably coupled to the body portion 440 on a second side of the longitudinal axis A-A. More specifically, the first lid 450 may be coupled to the body portion 440 adjacent to or along the first top edge 443 of the body portion 440 and the second lid 460 may be coupled to the body portion 440 adjacent to or along the second top edge 444 of the body portion 440. The first and second lids 450 460 may each be pivotable relative to the body portion 440. In an embodiment, the first and second lids 450, 460 may each be coupled to the body portion 440 by one or more hinges. As such, the first and second lids 450, 460 may be pivoted relative to the body portion 440 between an open position, as shown in FIG. 5B, and a closed position, as shown in FIG. 5A. In the open position, the first and second lids 450, 460 are pivoted in a direction away from the longitudinal axis A-A so that the open top end of the body portion 440 is fully exposed. In the closed position, the first and second lids 450, 460 are pivoted towards one another and towards the longitudinal axis A-A so that the first and second lids 450, 460 close at least a portion of the open top end of the body portion 440.

The first lid 450 may comprise a first connection feature 451. The second lid 460 may comprise a second connection feature 461. The first and second connection features 451, 461 may be configured to engage one another to lock the first and second lids 450, 460 in the closed position. The first and second connection features 451, 461 may be configured to be altered into an unlocked state to permit a user to alter the first and second lids 450, 460 from the closed position to the open position. In the exemplified embodiment, the first connection feature 451 comprises a post with a notch and the second connection feature 461 comprises a rod that is configured to nest within the notch and a knob that is configured to tighten against the post of the first connection feature 451 to achieve the locking engagement of the first and second connection features 451, 461. However, this is merely exemplary, and other structural features may be used for the first and second connection features 451, 461. For example, various combinations of indents, detents, tabs, recesses, spring loaded latches, fasteners such as screws, bolts, and the like, hook-and-loop, and the like may be used in different embodiments to lock the first and second lids 450, 460 in the closed position.

As best shown in FIG. 5D, the sides of the inlet portion 410 may diverge from one another with increasing distance from the wrapping portion 430 towards the first end 411. The first and second top edges 417, 418 diverge from one another moving in the direction from the second end 412 of the inlet portion 410 to the first end 411 of the inlet portion 410. This is due to the funnel shape of the inlet portion 410. Furthermore, the inner surface 414 of the inlet portion 410 may extend downwardly at an angle from the inner surface 441 of the wrapping portion 430, at least along a longitudinal centerline of the conformator 400.

Referring to FIGS. 5E and 5F, the relationship of the first and second lids 450, 460 when in the closed position will be described. As noted, the first and second lids 450, 460 may be locked in the closed position due to engagement between the first and second connection features 451, 461. The first lid 450 may comprise a first edge portion 452 and the second lid 460 may comprise a second edge portion 462. The first edge portion 452 of the first lid 450 may be a portion of the first lid 450 that comprises a first distal edge 454 of the first lid 450 which is located furthest from the first top edge 443 of the body portion 440. The second edge portion 462 of the second lid 460 may be a portion of the second lid 460 that comprises a second distal edge 464 of the second lid 460 which is located furthest from the second top edge 444 of the body portion 440.

The first edge portion 452 of the first lid 450 may comprise an exterior surface 453 which forms part of an outer surface of the first lid 450. The second edge portion 462 of the second lid 460 may comprise an interior surface 463 which forms part of an inner surface the second lid 460. When the first and second lids 450, 460 are in the closed position, the second edge portion 462 of the second lid 460 overlaps the first edge portion 452 of the first lid 450. Furthermore, a space 455 is maintained between the exterior surface 453 of the first edge portion 452 of the first lid 450 and the interior surface 463 of the second edge portion 462 of the second lid 460. In an embodiment, the first and second edge portions 452, 462 may be spaced apart by a small distance, in a range of 1-30 mm, more specifically 1-20 mm, and still more specifically 1-5 mm. The space 455 should be sufficiently large to enable an edge of the sheet of wrapping material to be located therein during the wrapping procedure as described below.

Referring sequentially to FIGS. 6A-6E, the operation of the system 100 will be described. As shown in FIG. 6A, a roll of wrapping material 600 is supported on the support rod 302 of the support assembly 300. The roll of wrapping material 600 comprises a wrapping material 601 that is configured to be wrapped around the cables or tubes within the system 100. The wrapping material 601 may be in the form of a sheet that is rolled up prior to use and unrolled during the wrapping process described herein. The wrapping material 601 may be a geotextile material, such as a geotextile mesh in some embodiments. Details regarding possible geotextile materials are described in U.S. Pat. No. 7,838,771 , the entirety of which is incorporated herein by reference. In other embodiments, the wrapping material 601 may be a polyethylene mesh material. In other embodiments, the wrapping material 601 may be a nonwoven geotextile made of 100% polypropylene staple filaments/fibers. The wrapping material 601 may be specifically designed to protect the cable or pipe that is being wrapped from puncture or other damage when it is buried in the ground and covered with the native material which may include dirt, rocks, and the like. Certa

As seen in FIG. 6A, the end of the wrapping material 601 is unrolled and moved through the system 100 below the inlet guide assembly 210, the trefoil guide assembly 230, and the outlet guide assembly 250. In some embodiments, pulling on the end of the wrapping material 601 will unroll the wrapping material 601 into its sheet form. FIG. 6A also illustrates three cables 700 extending through the inlet guide assembly 210 towards the trefoil guide assembly 230. In the exemplified embodiment, the cables 700 may be power cables. However, other cables or pipes may be used in alternative embodiments, such as gas pipes, steel pipes, PVC pipes, or the like. Any type of cable or pipe that is desired to be wrapped prior to burial underground may be used in the system 100 as described herein.

It should be appreciated that the cables 700 may be supported on a drum or reel that is upstream of the inlet guide assembly 210. The cables 700 may be unrolled from the drum or reel to move the cables 700 through the system. In one embodiment, during an initial setup phase the cables 700 are pulled manually through the system so that an end of the cables 700 protrudes from the exit guide assembly 290. The end of the cables 700 may then be fixed to a stationary support apparatus. Then, with the end of the cables 700 supported, the vehicle 50 supporting the frame 101 may move in a direction towards the drum or reel containing the cables 700 and away from the stationary support apparatus. At the same time, the drum or reel containing the cables 700 may be located on a trailer or other vehicle, which is also moving. As such, the cables 700 may be moved through the system 100 due to the system 100 and its components moving relative to the cables 700 which are held stationary. As the trailer or vehicle holding the drum or reel containing the cables 700 moves, the cables 700 may be unrolled from the drum or reel containing the cables 700.

As shown in FIG. 6B, the cables 700 and the wrapping material 601 continue to be pulled or moved through the system 100 with the wrapping material 601 located below/beneath the cables 700 with the cables 700 supported by the inlet guide assembly 210, the trefoil guide assembly 230, and the outlet guide assembly 250. When the cables 700 pass through the trefoil guide assembly 230, the cables 700 are forced into a trefoil arrangement with two of the cables 700 located beneath the third cable 700 which is supported by the two lower cables 700 at their interface.

Referring briefly to FIG. 6C, the cables 700 and the wrapping material 601 have moved through the system 100 such that at least a portion of the cables 700 and the wrapping material 601 are located within the wrapping passageway 403 of the conformator 400. Thus, as the wrapping material 601 reaches the conformator 400, the wrapping material 601 is moved into the wrapping passageway 403 of the conformator 400 along with the cables or pipes 700. In the wrapping passageway 403 of the conformator 400, the wrapping material 601 is initially located below the cables or pipes 700 with the cables or pipes 700 resting atop of the wrapping material 601. As the wrapping material 601 and the cables/pipes 700 move through the wrapping passageway 403, the conformator 400 causes the wrapping material 403 to wrap around the cables/pipes 700 to form a wrapped cable or pipe assembly.

FIG. 6D is a detail view of the wrapping of the wrapping material 601 around the cables/pipes 700 in the wrapping passageway 403 of the conformator 400. First, it is noted that the sheet of wrapping material 601 has a first edge portion 603 and a second edge portion 604. As the wrapping material 601 passes through the inlet 401 of the conformator 400, the first edge portion 603 extends into the first gap 471 defined by the first hook 470 and described above and the second edge portion 604 extends into the second gap 481 defined by the second hook 480. The first and second hooks 470, 480 are then able to maintain the sheet of wrapping material 601 in the wrapping passageway 403 as the wrapping material 601 is moved therethrough.

Further downstream, as the wrapping material 601 passes into the wrapping portion 430 of the conformator 400, the first and second lids 450, 460 cause the wrapping material 601 to wrap around the cables/tubes 700. Specifically, the wrapping material 601 follows the contour of the interior surfaces of the wrapping portion 430 (defined by the body portion 440 and the first and second lids 450, 460). Furthermore, the first edge portion 603 of the wrapping material 601 extends into the space 455 between the overlapping portions of the first and second lids 450, 460. This ensures that the wrapping material 601 wraps fully around the circumference of the cables/tubes 700.

Referring to FIG. 6E, the cables/tubes 700 are wrapped by the wrapping material 601 to form a wrapped cable or pipe assembly 750. The wrapped cable or pipe assembly 750 then moves through the winder subsystem 500 so that the winding material 520 can be wound around the exterior of the wrapped cable or pipe assembly 750. The winding material 520 helps to maintain the wrapping material 601 wrapped around the cables/pipes 700. Specifically, without the winding material 520 or some other securing mechanism (adhesives, etc.), the wrapping material 601 could simply become unwrapped from the cables or tubes 700. The winding material 520 wraps helically around the exterior of the wrapped cable or pipe assembly 750, thereby securing the wrapping material 601 around the outside of the cables or pipes 700.

As noted above, in some embodiments the system 100 is mounted on a vehicle, such as the vehicle 50 shown in FIG. 1. As discussed above, the vehicle 50 may travel in the upstream direction (see arrow DIR1 shown in FIG. 6E) while the end of the cables/tubes 700 are fixed and stationary. The movement of the vehicle 50 may cause the cables/tubes 700 and the wrapping material 601 to move through the system so that the wrapping material 601 becomes wrapped around the cables/tubes 700. In some embodiments, it may be desirable to ensure that the winding material 520 is wound consistently around the exterior of the wrapping material 601. Specifically, it may be desirable for the pitch of the helical shape of the winding material 520 to remain consistent along the full length of the wrapped cables/tubes. In one embodiment, a speed of rotation of the drum 510 of the winder subsystem 500 may be correlated to a speed of movement of the vehicle 50. For example, in an embodiment, increasing the speed of movement of the vehicle 50 may result in an increase in the speed of rotation of the drum 510. Similarly, decreasing the speed of movement of the vehicle 50 may result in a decrease in the speed of rotation of the drum 510. Correlating the speed of movement of the vehicle 50 to the speed of rotation of the drum 510 will ensure a consistent winding of the winding material 520 around the wrapped cable or pipe assembly 750.

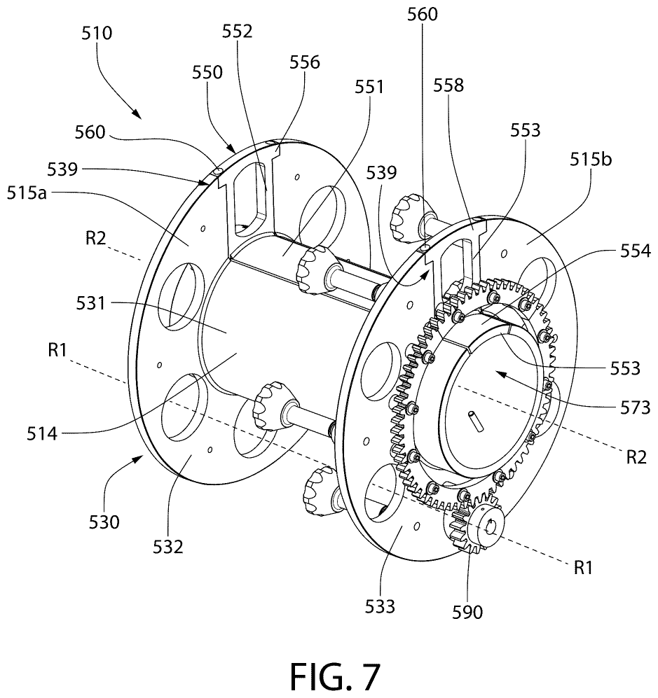

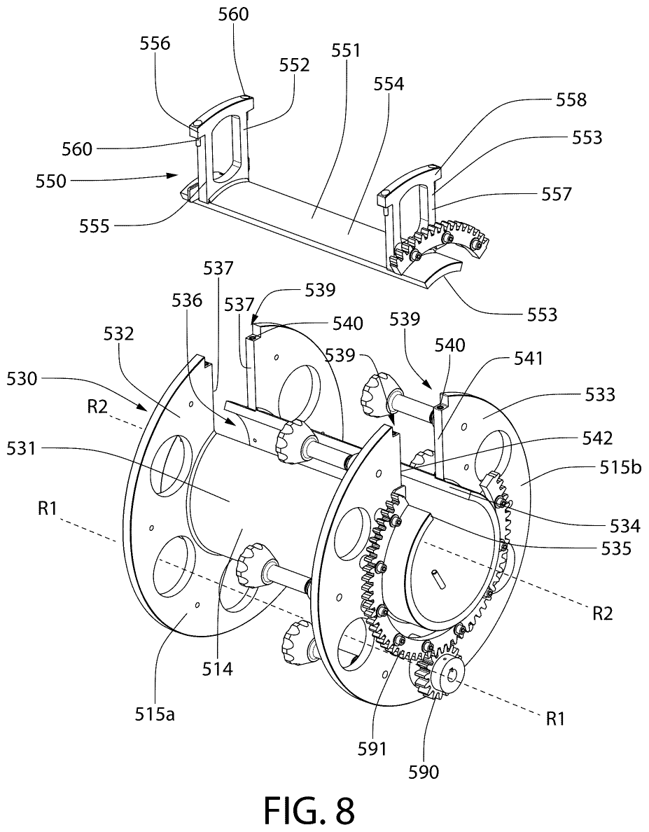

Referring to FIGS. 7 and 8, the drum 510 of the winder subsystem 500 will be described in accordance with an alternative embodiment of the present invention. The drum 510 comprises the main body portion 514, the first flange 515a, and the second flange 515b as described previously. Various gears are shown in FIGS. 7 and 8 which facilitate the rotation of the drum 510 as described previously. In particular, a motor (not shown) may be operably coupled to a driver gear 590 to cause the driver gear 590 to rotate about a first rotational axis R1-R1. Furthermore, an outer surface of the second flange 515b may comprise a driven gear 591 thereon that is operably coupled to the driver gear 590. The driven gear 591 may interact/engage with the driver gear 590 to cause the drum 510 to rotate about a second rotational axis R2-R2 when the motor is rotating the driver gear 590. The second rotational axis R2-R2 may be parallel to the first rotational axis R1-R1.

The main difference between this embodiment and the one previously described is that the drum 510 is formed from to parts that are detachably coupled together. This may allow a user or operator to access the wrapped cable or pipe located within the winder passageway 513 without having to first remove the wrapped cable or pipe from the winder passageway 513. Specifically, detaching the two parts of the drum 510 will allow the user or operator to remove the cables or pipes without having to cut the cables or pipes.

Specifically, the drum 510 may comprise a first drum component 530 and a second drum component 550 that are detachably coupled together. The first drum component 530 may be much larger than the second drum component 550 and may therefore form a majority of the drum 510. The first drum component 530 may comprise at least 60% or at least 70% or at least 80% or at least 90% of each of the main body 514, the first flange 515a, and the second flange 515b. The first drum component 530 may comprise a first main body portion 531 of the main body 514, a first flange portion 532 of the first flange 515a, and a first flange portion 533 of the second flange 515b. The first portion main body portion 531 of the main body 514 may be U-shaped or C-shaped and may comprise first and second edges 534, 535 that extend the length of the main body portion 514. The first and second edges 534, 535 may be spaced apart from one another by an elongated gap 536 that extends from the first end (inlet) of the main body portion 514 to the second end (outlet) of the main body portion. The elongated gap 536 may form an opening into the winder passageway 513 from above, which may provide the user or operator with access to the wrapped tubes or pipes located within the winder passageway 513.

The first flange portion 532 of the first flange 515a may comprise first and second edges 537, 538 that are located on opposite sides of the elongated gap 536. The first flange portion 532 of the second flange 515b may comprise first and second edges 541, 542 located on opposite sides of the elongated gap 536. The first flange portion 532 may comprise notches 539 formed into the periphery of the first flange portion 532 at each of the first and second edges 537, 538, 541, 542. The first flange portion 532 may further comprise an opening 540 formed into first flange portion 532 at the notches 539 adjacent to each of the first and second edges 537, 538, 541, 542. The openings 540 may be configured to receive fasteners to facilitate the attachment of the second drum component 550 to the first drum component 530.

The second drum component 550 may comprise a second main body portion 551 of the main body 514, a second flange portion 552 of the first flange 515a, and a second flange portion 553 of the second flange 515b. The second main body portion may be sized and configured to fit within and fully enclose the elongated gap 536 between the first and second edges 534, 535 of the first portion of the main body 531 formed by the first drum component 530. The second main body portion 551 may be an arcuate plate. The second main body portion 551 may comprise an upper surface 554 and a lower surface 555, with the lower surface 555 facing the winder passageway 513 when the second drum component 550 is coupled to the first drum component 530. The second flange portion 552 of the first flange 515a may comprise at least one first post portion 555 that protrudes from the upper surface 554 of the second main body portion 551 and at least one first connecting portion 556 that protrudes from two opposing sides of the at least one first post portion 555. Similarly, the second flange portion 553 of the second flange 515b may comprise at least one second post portion 557 that protrudes from the upper surface 555 of the second main body portion 551 and at least one second connecting portion 558 that protrudes from two opposing sides of the at least one second post portion 557.

When the second drum component 550 is positioned on the first drum component 530 with the second main body portion 551 located in the elongated gap 536, the at least one first connecting portion 556 nests within the notches 539 of the first flange portion 532 of the first flange 515a and the at least one second connection portion 558 nests within the notches 539 first flange portion 533 of the second flange 515b. Fasteners 560 may then be inserted through the first and second connection portions 556, 558 and into the openings 540 to fasten the second drum component 550 to the first drum component 530. The fasteners 560 may be bolts, screws, or the like.

In the exemplified embodiment, the second drum component 550 is coupled to the first drum component 530 via fasteners 560. In an alternative embodiment, the second drum component 550 may be hingedly coupled to the first drum component 530 so that the second drum component 550 may be pivoted relative to the first drum component 530 between closed and open states. In the open state, a passageway is formed through the first main body portion 531 of the first drum component 530 to provide a user or operator with access into the winder passageway 513 as described herein.

As best shown in FIG. 8, each of the first and second drum components 530, 550 comprise portions of the driven gear 591. When the second drum component 550 is coupled to the first drum component 530, the two parts of the driven gear 591 form an annular driven gear that allows for the drum 510 to rotate about the second rotational axis R2-R2 as described herein.

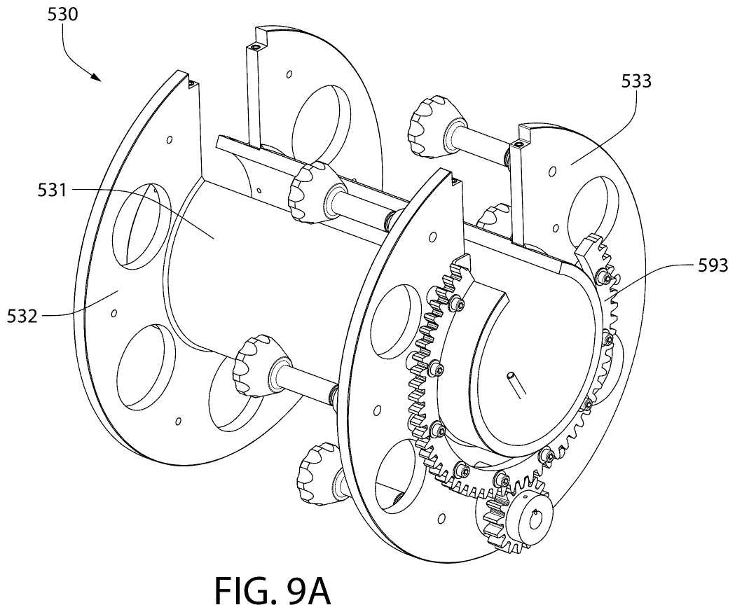

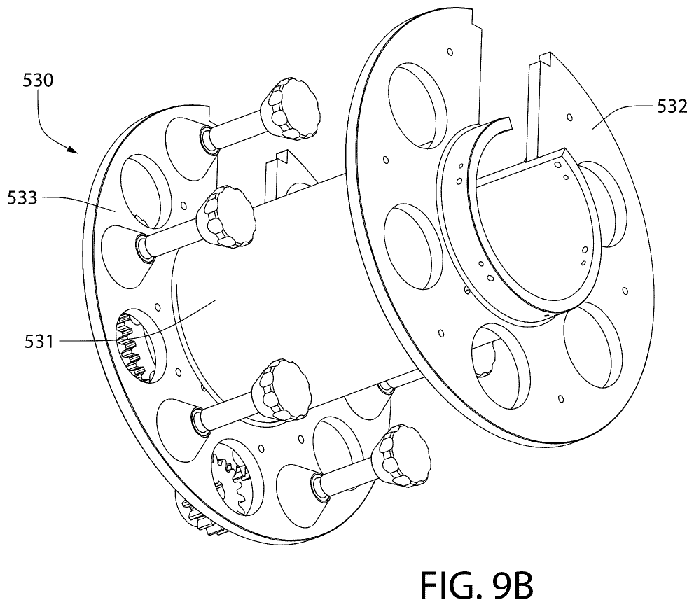

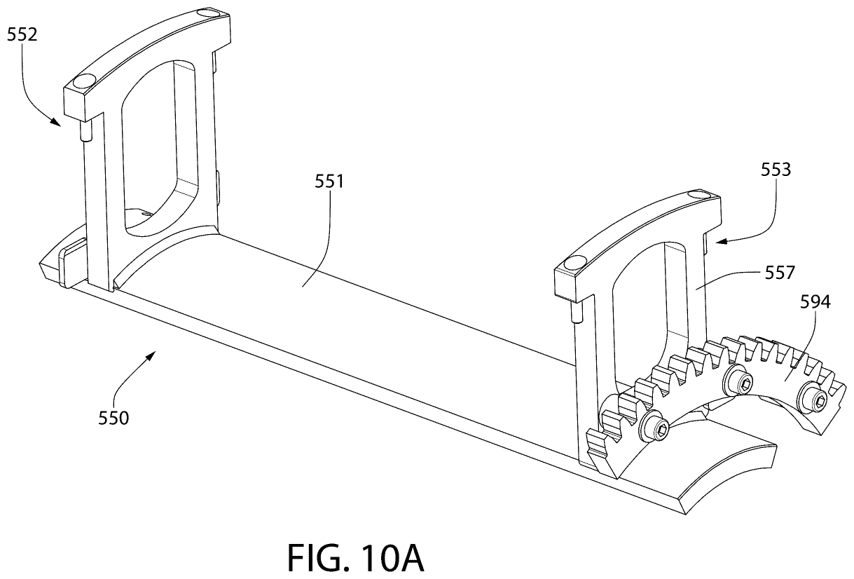

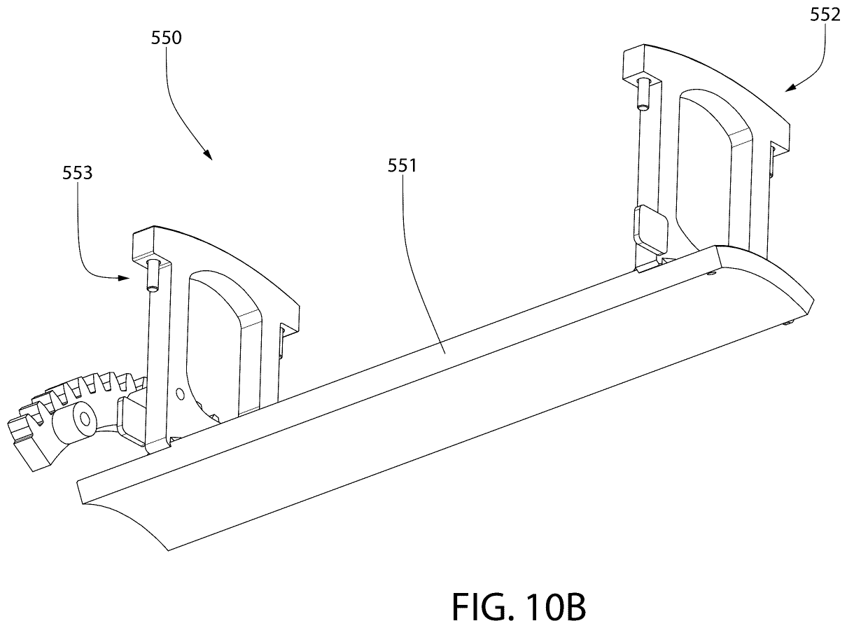

FIGS. 9A and 9B are additional views of the first drum component 530. FIGS. 10A and 10B are additional views of the second drum component 550. These views provide large illustrations of the two drum components 530, 550 for clarity of understanding. As noted, the first drum component 530 comprises a first portion 593 of the driven gear 591 and the second drum component 550 comprises a second portion 594 of the driven gear 591. The first portion 593 of the driven gear 591 may be couped to an outer surface of the first flange portion 533 of the second flange 515b. The second driven portion 594 of the driven gear 591 may be coupled to an outer surface of the second flange portion 553 of the second flange 515b. The various portions of the driven gear 591 may be coupled to the first and second drum components 530, 550 with fasteners such as bolts, screws, rivets, or the like. The second driven portion 594 of the driven gear 591 may be coupled to the second post portion 557 of the second flange portion 553.

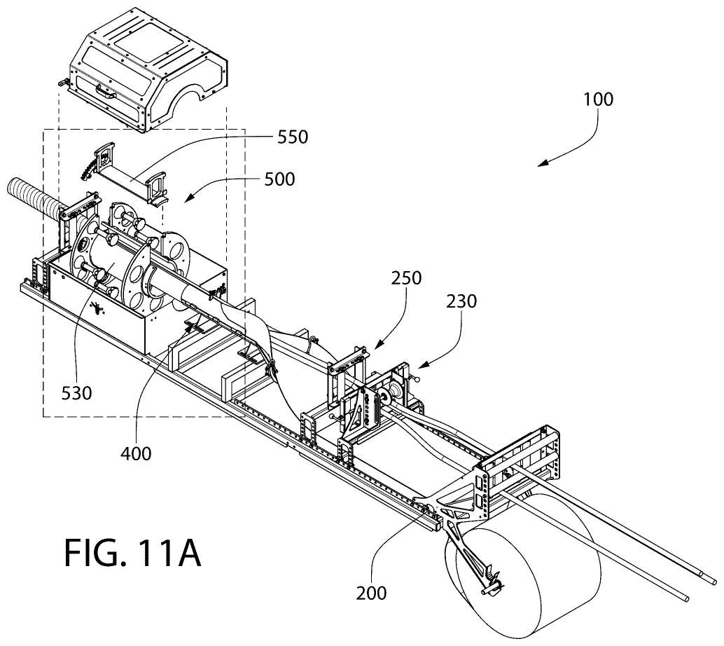

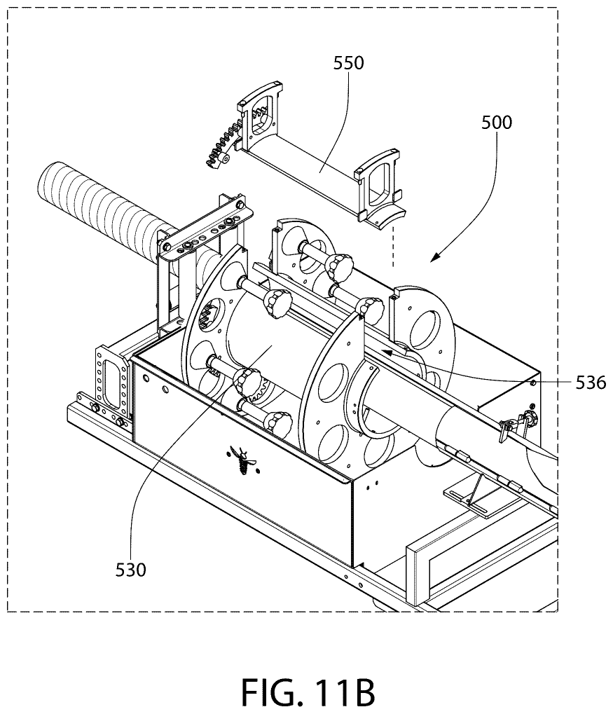

Referring to FIGS. 11A and 11B, the system 100 is illustrated using the two-part drum in the winder subsystem as described above with reference to FIGS. 7-10B. The two-part drum is part of the winder subsystem 500, and in FIGS. 11A and 11B the second drum component 550 is illustrated detached and exploded away from the first drum component 530. The winder subsystem 500 is downstream of the conformator 400, and thus as described herein the wrapped cable or pipe assembly is located within the winder passageway 513. When the system 100 is being used, there is a large length of the unwrapped cable or pipe located upstream of the winder subsystem 500 and a large length of the wrapped cable or pipe assembly located downstream of the winder subsystem 500. Thus, if there are issues that occur and the wrapped cable or pipe assembly needs to be removed form the winder subsystem 500, with a standard one-piece drum the user or operator would have to slowly move the cable in the reverse direction back out through the winder passageway 513. The two-part drum 530, 550 resolves this by allowing the user or operator to remove the wrapped cable or pipe assembly through the elongated gap 536 described above.

In one embodiment, the elongated gap 536 may have a width that is larger than a diameter of the wrapped cable or pipe assembly. In such an embodiment, once the second drum component 550 is detached form the first drum component 530, the wrapped cable or pipe assembly can be pulled through the elongated gap 536 for removal or inspection or the like.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A system for wrapping at least one cable or pipe, the system comprising:
a guide assembly configured to support at least one cable or pipe;
a support assembly configured to support a roll of a wrapping material;
a conformator comprising an inlet, an outlet, and a wrapping passageway extending from the inlet to the outlet, the conformator configured to receive the wrapping material and the at least one cable or pipe within the wrapping passageway and to wrap the wrapping material around the at least one cable or pipe as the wrapping material and the at least one cable or pipe are moved through the wrapping passageway, the conformator comprising:
an inlet portion configured to receive the at least one cable or pipe and the wrapping material, the inlet portion being half-funnel shaped such that a diameter of the inlet portion decreases in a direction from the inlet of the conformator towards a distal end of the inlet portion; and
a wrapping portion extending from the distal end of the inlet portion and being configured to wrap the wrapping material around an exterior of the at least one cable or pipe so that a wrapped cable or pipe assembly exits the conformator at the outlet of the conformator; and
a winder subsystem located downstream of the outlet of the conformator and configured to wind a thread around an exterior of the wrapped cable or pipe assembly to secure the wrapping material to the at least one cable or pipe.

2. The system according to claim 1 wherein a diameter of the wrapping portion of the conformator is constant from the distal end of the inlet portion to the outlet of the conformator.

3. The system according to claim 1 further comprising:
the wrapping portion comprising a body portion having a semi-cylindrical shape and a longitudinal axis, the body portion being oriented horizontally and having an open top end;
a first lid pivotably coupled to the body portion on a first side of the longitudinal axis;
a second lid pivotably coupled to the body portion on a second side of the longitudinal axis; and
wherein each of the first and second lids is alterable between an open position whereby the first and second lids are pivoted away from the longitudinal axis and a closed position whereby the first and second lids close at least a portion of the open top end of the body portion of the wrapping portion.

4. The system according to claim 3 further comprising:
the first lid comprising a first connection feature;
the second lid comprising a second connection feature; and
wherein when the first and second lids are in the closed position, the first and second connection features are configured to engage one another to lock the first and second lids in the closed position.

5. The system according to claim 4 wherein when the first and second lids are in the closed position, a second edge portion of the second lid overlaps a first edge portion of the first lid while a space is maintained between an interior surface of the second edge portion of the second lid and an exterior surface of the first edge portion of the first lid.

6. The system according to claim 5 wherein as the at least one cable or pipe and the wrapping material move axially through the wrapping passageway of the conformator, a first edge portion of the wrapping material is configured to extend into the space between the interior surface of the second edge portion of the second lid and the exterior surface of the first edge portion of the first lid so that the first edge portion of the wrapping material overlaps a second edge portion of the wrapping material and the wrapping material fully encloses the exterior of the at least one cable or pipe.

7. The system according to claim 1 further comprising:
the winder subsystem comprising a drum that is configured to rotate about a rotational axis, the drum having an inner surface that defines a winder passageway and an outer surface;
a plurality of reel support members coupled to the drum, each of the plurality of reel support members configured to support a reel of a winding material; and
wherein the plurality of reel support members are coupled to the drum so that the plurality of reel support members rotate along with the disc, during which the winding material winds around the wrapped cable or pipe assembly as the wrapped cable or pipe assembly passes through the winder passageway of the drum of the winder subsystem.

8. The system according to claim 7 further comprising:
a vehicle, the guide assembly, the support assembly, the conformator, and the winder subsystem being mounted on the vehicle; and
wherein a speed of rotation of the drum is correlated to a speed of movement of the vehicle, such that increasing the speed of movement of the vehicle results in an increase in the speed of rotation of the drum and decreasing the speed of movement of the vehicle results in a decrease in the speed of rotation of the drum to maintain a consistent winding of the winding material around the wrapped cable or pipe assembly.

9. The system according to claim 1 further comprising:
the conformator comprising a longitudinal axis that extends from the inlet of the conformator to the outlet of the conformator;
the inlet portion of the conformator being oriented horizontally and having an open top end and an inner surface, the inner surface being concave;
a first hook member coupled to the inlet portion of the conformator and extending over a first portion of the inner surface of the inlet portion located on a first side of the longitudinal axis, wherein a first gap exists between the first hook member and the first portion of the inner surface of the inlet portion of the conformator;
a second hook member coupled to the inlet portion of the conformator and extending over a second portion of the inner surface of the inlet portion located on a second side of the longitudinal axis, wherein a second gap exists between the second hook member and the second portion of the inner surface of the inlet portion of the conformator; and
wherein as the wrapping material passes through the inlet of the conformator, a first edge portion of the wrapping material extends into the first gap, a second edge portion of the wrapping material extends into the second gap, and a central portion of the wrapping material is located between the first and second hook members.

10. The system according to claim 9 wherein the inlet portion of the conformator comprises a first end that forms the inlet of the conformator, wherein the first and second hook members are located adjacent to the first end of the inlet portion of the conformator, and wherein the first and second hook members extend over the first and second portions of the inner surface of the inlet portion without protruding beyond the first end of the inlet portion.

11. The system according to claim 10 wherein the inlet portion of the conformator comprises a first top edge located on a first side of the longitudinal axis and a second top edge located on a second side of the longitudinal axis, the first hook member extending over the first top edge of the conformator and the second hook member extending over the second top edge of the conformator.

12. The system according to claim 1 further comprising:
the inlet portion of the conformator comprising an inner surface and the wrapping portion of the conformator comprising an inner surface, the inner surface of the inlet portion angled downwardly from the inner surface of the wrapping portion in a direction from the distal end of the inlet portion towards the inlet of the conformator.

13. The system according to claim 1 further comprising:
the guide assembly comprising an inlet guide assembly, a trefoil guide assembly located downstream of the inlet guide assembly, and an outlet guide assembly located downstream of the trefoil guide assembly and upstream of the conformator; and
the support assembly comprising a support rod that is configured to support the roll of the wrapping material, wherein the support rod is located below the inlet guide assembly.

14. The system according to claim 13 wherein the inlet guide assembly is spaced a first distance from the trefoil guide assembly and the trefoil guide assembly is spaced a second distance from the outlet guide assembly, the first distance being greater than the second distance.

15. The system according to claim 14 wherein the outlet guide assembly is spaced a third distance from the inlet of the conformator, the third distance being greater than the second distance and less than the first distance.

16. The system according to claim 1 wherein the wrapping portion of the conformator further comprises:
a bottom portion;
a first sidewall extending from the bottom portion to a first edge, the first sidewall comprising a first edge portion comprising the first edge and an inner surface;
a second sidewall extending from the bottom portion to a second edge, the second sidewall comprising a second edge portion comprising the second edge and an outer surface; and
wherein the first edge portion of the first sidewall overlaps the second edge portion of the second side portion such that a space exists between the inner surface of the first edge portion and the outer surface of the second edge portion, wherein the wrapping material extends into the space during the wrapping of the at least one cable or pipe with the wrapping material.

17. The system according to claim 1 wherein the winder subsystem comprises a drum comprising:
a main body portion defining a winder passageway having an inlet and an outlet, a first flange protruding from the main body portion adjacent to the inlet, and a second flange protruding from the main body portion adjacent to the outlet;
a first drum component comprising a first portion of the main body portion, a first portion of the first flange, and a first portion of the second flange, the first drum component comprising an elongated gap that extends from the inlet to the outlet and forms an opening into the winder passageway; and
a second drum component comprising a second portion of the main body portion, a second portion of the first flange, and a second portion of the second flange, wherein the second drum component is configured to be detachably coupled to the first drum component between an attached state wherein the second portion of the main body portion of the second drum nests within the elongated gap and closes the opening into the winder passageway and a detached state wherein the elongated gap is exposed.

18. The system according to claim 1 wherein the winder subsystem comprises a drum comprising:
a first drum component forming a first portion of a main body portion of the drum; and
a second drum component forming a second portion of the main body portion of the drum;
the second drum component being detachably coupled to the first drum component between an attached state wherein the main body portion of the drum formed collectively by the first and second drum components is a cylindrical body defining a winder passageway and a detached state wherein an elongated gap of the first portion of the main body portion forms an opening into the winder passageway.

19. A system for wrapping at least one cable or pipe, the system comprising:
a guide assembly configured to receive and support the at least one cable or pipe, the guide assembly comprising an inlet guide assembly;
a support assembly configured to support a roll of a wrapping material, the support assembly located below the inlet guide assembly;
a conformator comprising an inlet, an outlet, and a wrapping passageway extending along a longitudinal axis from the inlet to the outlet, the conformator configured to receive the wrapping material and the at least one cable or pipe within the wrapping passageway and to wrap the wrapping material around the at least one cable or pipe as the wrapping material and the at least one cable or pipe are moved through the wrapping passageway, the conformator comprising:
a funnel shaped inlet portion, the funnel shaped inlet portion being horizontally oriented and comprising the inlet of the conformator, a distal end opposite the inlet, and an open top end;
a cylindrical shaped wrapping portion, the cylindrical shaped wrapping portion being horizontally oriented and comprising the outlet of the conformator and an open top end, the cylindrical shaped wrapping portion being integrally connected to the distal end of the funnel-shaped inlet portion;
a first lid pivotably coupled to the cylindrical shaped wrapping portion on a first side of the longitudinal axis;
a second lid pivotably coupled to the cylindrical shaped wrapping portion on a second side of the longitudinal axis;
wherein each of the first and second lids is alterable between an open position whereby the first and second lids are pivoted away from the longitudinal axis and a closed position whereby the first and second lids close at least a portion of the open top end of the cylindrical shaped wrapping portion; and
wherein when the first and second lids are in the closed position, a second edge portion of the second lid overlaps a first edge portion of the first lid while a space is maintained between the second edge portion of the second lid and the first edge portion of the first lid.

20.-22. (canceled)

23. A system for wrapping at least one cable or pipe, the system comprising:
a guide assembly configured to support at least one cable or pipe;
a support assembly configured to support a roll of a wrapping material;
a conformator configured to wrap the wrapping material around the at least one cable or pipe to form a wrapped cable or pipe assembly; and
a winder subsystem located downstream of the conformator and configured to wind a thread around an exterior of the wrapped cable or pipe assembly to secure the wrapping material to the at least one cable or pipe, the winder subsystem comprising a drum comprising:
a first end and, a second end, and a winder passageway that extends from
the first end to the second end;
a first drum component comprising a first main body portion having an elongated gap that extends from the first end of the drum to the second end of the drum; and
a second drum component comprising a second main body portion that extends from the first end of the drum to the second end of the drum; and
wherein the second drum component is alterable between an attached state wherein the second main body portion of the second drum component is positioned within the elongated gap of the first main body portion of the first drum and a detached state wherein the second drum component is detached from the first drum component and the elongated gap defines an opening into the winder passageway of the drum.

24.-31. (canceled)
